(19) United States
(12) Patent Application Publication
(10) Pub. No.: US 2014/0112130 A1
(43) Pub. Date: Apr. 24, 2014

(54) METHOD FOR SETTING PACKET FORWARDING RULE AND CONTROL APPARATUS USING THE METHOD

(71) Applicant: Electronics And Telecommunications Research Institute, Daejeon (KR)

(72) Inventors: Sunhee YANG, Daejeon (KR); Young Hwa Kim, Daejeon (KR); Saehoon KANG, Daejeon (KR)

(73) Assignee: Electronics And Telecommunications Research Institute, Daejeon (KR)

(21) Appl. No.: 14/061,340

(22) Filed: Oct. 23, 2013

(30) Foreign Application Priority Data
Oct. 23, 2012 (KR) 10-2012-0118127
Oct. 23, 2013 (KR) 10-2013-0126518

(51) Int. Cl. H04L 12/851

(52) U.S. Cl. CPC H04L 47/24
USPC 370/230

(57) ABSTRACT

In a network including a plurality of switches, different priority levels are assigned to different services based on a frequently requested service list provided from an end system including an end host and a server, and a forwarding rule containing path information for forwarding data packets is selectively set according to the priority levels. A first forwarding rule set for a service of the first priority level is loaded to corresponding ones of the plurality of switches.

### CROSS-REFERENCE TO RELATED APPLICATION

This application claims priority to and the benefit of Korean Patent Application No. 10-2012-0118127 and 10-2013-0126518 filed in the Korean Intellectual Property Office on Oct. 23, 2012 and Oct. 23, 2013, the entire contents of which are incorporated herein by reference.

### BACKGROUND OF THE INVENTION

1. Field of the Invention

The present invention relates to setting a forwarding rule, and more particularly, to a method for setting a packet forwarding rule in an open network based on centralized control, and a control apparatus using the same.

2. Description of the Related Art

In a distributed control network, network path allocation is controlled by connection information between physical equipment and the operating characteristics of L2 and L3 protocols. This reduces the utilization of network and computing resources and reduces flexibility, and involves limitations such as longer preparing time in deploying—new services and increased complexity of network construction and operation. As a solution to improve the ineffectiveness of such a distributed control architecture, technologies like software defined networks (SDN) and open APIs (application program interfaces) such as OpenFlow are now being developed, in which a centralized controller collects comprehensive information about the topology and network status, and data forwarding paths between end systems is flexibly controlled in response to user application requests.

In such an open network based on centralized control, when traffic is generated from an end system (host or server), this traffic is normally directed to the centralized controller, and the controller receiving the traffic determines the forwarding path and packet processing rules based on the packet header information and topology information collected by the controller, and path allocation policies, and loads the determined forwarding rule to corresponding switches, thereby setting a forwarding path.

Although the centralized controller gives flexibility to network operations by allocating forwarding path flexibly-based on various information. There are limitations to the scalability in the number of new flows that can be processed per unit time, and any delay in processing a new flow is lengthened.

To solve these problems, methods such as using a wildcard rule to prevent new flows from reaching the controller or presetting a fixed path for the switches are used. However, these methods impose severe limitations on flexibility, which is required to differentiate services or paths by finely splitting traffic, and bring about performance degradation of the switches due to an increase of forwarding rule entries.

### SUMMARY OF THE INVENTION

The present invention has been made in an effort to provide a method for setting a forwarding rule to efficiently forward a packet in an open network based on centralized control, and a control apparatus using the same.

An exemplary embodiment of the present invention provides a method for setting a forwarding rule in a network comprising a plurality of switches. The method includes receiving frequently requested service list from an end system comprising an end host and a server; assigning different priority levels to different services based on the frequently requested service list, and selectively setting a forwarding rule containing path information for forwarding data packets according to the priority levels; preliminarily loading a first forwarding rule for a service of the first priority level to corresponding ones of the plurality of switches; in and storing and managing forwarding rules set for services other than the service of the first priority level, without preliminarily loading the same to the corresponding switches.

The storing and managing may include storing and managing a second priority groups of forwarding rule set for a service classified as a second priority level, without loading the same to corresponding ones of the plurality of switches, wherein no forwarding rule is set for services of a third priority level other than the service of the second priority level.

The method may further include receiving of data packets; and if the data packets correspond to the service of the second priority level, loading the second forwarding rule set for the service of the second priority level to the corresponding ones of the plurality of switches to forward the data packets.

Also, the method may further include if the data packets do not correspond to the service of the second priority level, determining that the data packets correspond to a service of the third priority level; setting a third forwarding rule for the service of the third priority level; and loading the third forwarding rule to corresponding ones of the plurality of switches to forward the data packets.

When data packets are generated for the service of the first priority level, the generated data packets may be immediately forwarded through the switches corresponding to the first forwarding rule.

The storing and managing may include storing information regarding the first forwarding rule set for the service of the first priority level in a first table, and storing information regarding the second forwarding rule may set for the service of the second priority level in a second table. In case, the method may further include, after the preliminary setting, updating the state of a path corresponding to the first forwarding rule stored in the first table to Loaded.

In addition, the method may further include setting the forwarding rules when the end system checks in to the network; and deleting information regarding the forwarding rules from the tables when the end system checks out of the network.

The frequently requested service list may include the rankings of accessed services, a URL (uniform resource indicator) address, network access information including source IP address, source MAC address, destination IP address, and port information, and a cumulated number of accesses per unit of time.

Another exemplary embodiment of the present invention provides a control apparatus for setting and controlling a forwarding rule in a network comprising a plurality of switches. The apparatus includes scalable forwarding rule manager that assigns different priority levels to different services based on a frequently requested service list provided from an end system comprising an end host and a server, and selectively sets a forwarding rule containing path information for forwarding data packets according to the priority levels; a path manager that preliminarily loads a first forwarding rule set for a service of a first priority level to corresponding ones of the plurality of switches; a first table that stores information about the first forwarding rule set for the service of the first priority level; and a second table that stores information about a second forwarding rule set for a service of a second priority level, wherein the second forwarding rule for the service of the second priority level is stored and managed without being preliminarily loaded to corresponding switches.

The scalable forwarding rule manager may set no forwarding rule for services other than the services of the first and second priority levels.

Upon receiving data packets, the scalable forwarding rule manager may search the second table to find a matching forwarding rule, and if the data packets correspond to the service of the second priority level and the matching forwarding rule exists in the second table, load the second forwarding rule set for the service of the second priority level to the corresponding ones of the plurality of switches.

If no forwarding rule matching the data packets exists in the second table, the scalable forwarding rule manager may determine that the data packets correspond to a service of a third priority level and sets a third forwarding rule, and load the third forwarding rule to corresponding ones of the plurality of switches.

When data packets are generated for the service of the first priority level, the generated data packets may be not provided to the scalable forwarding rule manager but are immediately forwarded through the switches corresponding to the first forwarding rule.

The first and second tables each may include a rule ID, which is identification information about a set forwarding rule, Host/VM ID, which is identification information of an end system that has accessed a service, flow information, and path state, wherein the flow information may include at least either source IP address, source MAC address, destination IP address, port information, traffic rate, or path list, and the path state comprises at least either Ready, which indicates a state before path configuration, Loaded, which indicates the completion of path configuration, or Abnormal.

If the end system checks out of the network, the information stored in the first and second tables may be deleted.

Also, the apparatus may further include a third table that stores information corresponding to the service of the third priority level.

### BRIEF DESCRIPTION OF THE DRAWINGS

FIG. 1 is a view showing a network environment according to an exemplary embodiment of the present invention.

FIG. 2 is a view showing the structure of a packet forwarding rule control apparatus according to an exemplary embodiment of the present invention.

FIG. 3 is an illustration showing a frequently requested service list according to an exemplary embodiment of the present invention.

FIG. 4 is a view showing the structures of tables according to an exemplary embodiment of the present invention.

FIG. 5 is an overall flowchart of a method for setting a packet forwarding rule according to an exemplary embodiment of the present invention.

FIG. 6 to FIG. 8 illustrate first through third forwarding rule setting procedures in a packet forwarding rule setting method according to an exemplary embodiment of the present invention.

FIG. 9 to FIG. 12 are detailed flowcharts of a method for setting a packet forwarding rule according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout this specification and the claims which follow, unless explicitly described to the contrary, the word “comprise” and variations such as “comprises” or “comprising” will be understood to imply the inclusion of stated elements but not the exclusion of any other elements.

Now, a method for setting a packet forwarding rule and a control apparatus using the same according to an exemplary embodiment of the present invention will be described.

In an exemplary embodiment of the present invention, when a device is connected to a network controller acting as a centralized controller, access frequency is divided into a plurality of levels (e.g., three levels) based on the device's network service/application access history information. For services of a first priority level, which are most frequently accessed, path information is preliminarily calculated and set for the corresponding switches to reduce the load on the network controller and minimize service response delay time. For services of a second priority level, which are second most frequently accessed, path information is preliminarily calculated but held on standby without being set for the corresponding switches and set for the corresponding switches when traffic actually occurs. As a result, service response delay time can be shortened. For services of the lowest priority level, which are not frequently accessed, a path is found at a point in time when traffic occurs, and information about the found path is set for the corresponding switches. Accordingly, the number of paths that the network controller and the switches have to maintain can be optimized.

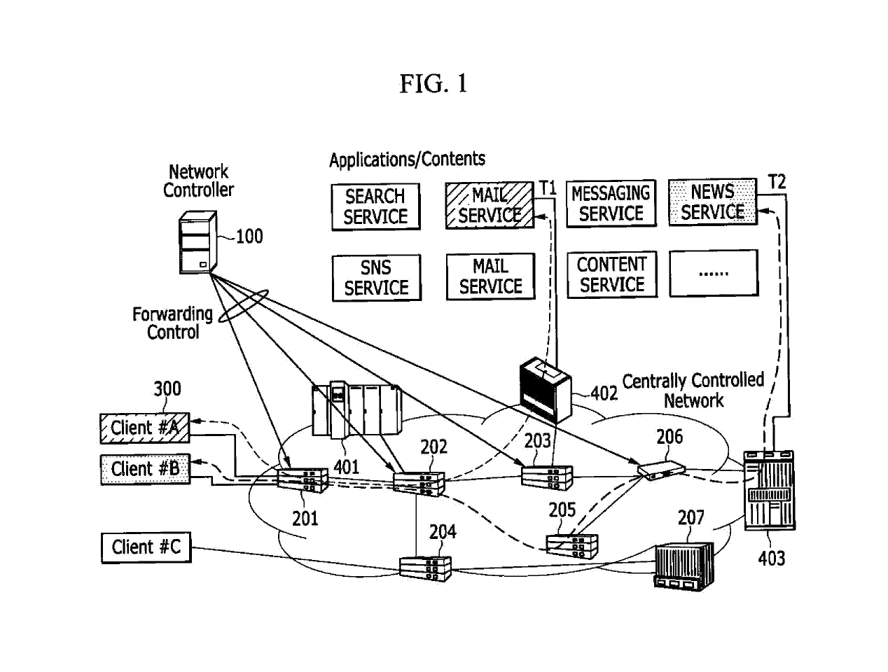

FIG. 1 is a view showing a network environment according to an exemplary embodiment of the present invention.

As shown in the attached FIG. 1, in a network according to an exemplary embodiment of the present invention, a plurality of open switches 201 to 207 (including virtual switches) are connected to a centralized network controller 100, and an end host 300 is connected to the plurality of open switches 201 to 207.

Also, a plurality of servers 401 to 403 are connected to the end host 300, and each server can be either virtualized or act as a physical server to provide a variety of applications and content.

Traffic is exchanged between the end host 300 and the servers or between the servers according to a service request (T1 and T2). To this end, the network controller 100 sets and controls a forwarding rule in a centralized way. The network controller 100 collects connection and resource information of network devices including switches to configure and manage topology information, and performs a path control function for calculating a proper path between a source and a destination. That is, the network controller 100 determines how to process traffic coming from each switch and which path the traffic takes in a centralized way, and instructs each switch to set, delete, or modify a traffic forwarding rule.

The network according to the exemplary embodiment of the present invention to which the network controller 100 of this type applies is an open network, for example, an OpenFlow network.

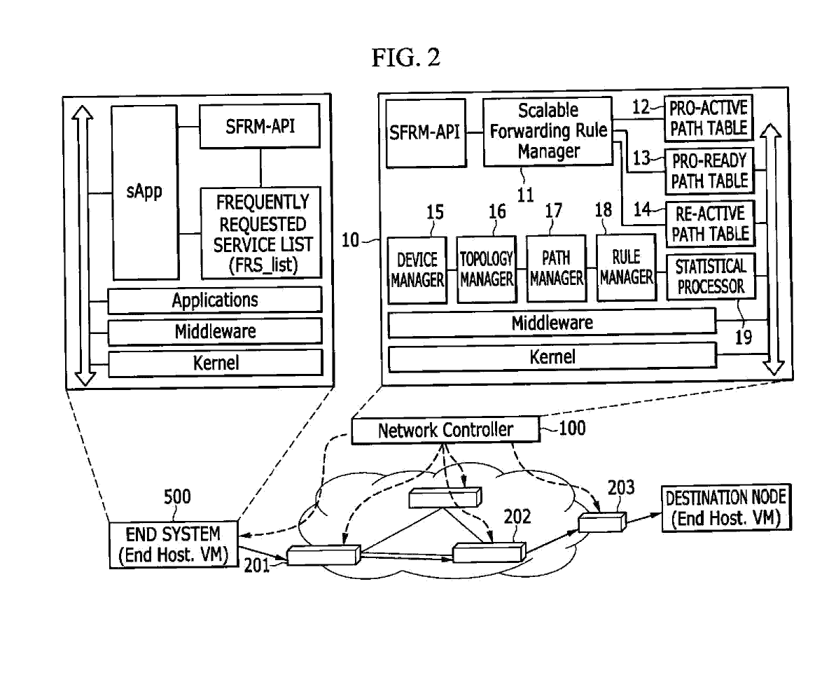

FIG. 2 is a view showing the structure of a packet forwarding rule control apparatus according to an exemplary embodiment of the present invention. As shown in FIG. 2, the packet forwarding rule control apparatus 10 according to the exemplary embodiment of the present invention controls forwarding operations of the switches within the network. The packet forwarding rule control apparatus 10 can be located within the network controller 100.

To this end, the packet forwarding rule control apparatus 10 includes a scalable forwarding rule manager (SFRM) 11, a first table 12, a second table 13, and a third table 14, and further includes a device manager 15, a topology manager 16, a path manager 17, a rule manager 18, and a statistical processor 19.

The SFRM 11 of the packet forwarding rule control apparatus 10 controls and manages forwarding rules by classifying them into three priority levels based on network service history information (including a frequently requested service list) of end hosts 300.

That is, the first priority level is assigned to most frequently requested services that end systems each including an end host frequently access, based on a network service history, a forwarding rule is preliminarily created for the most frequently requested services of the first priority level, and the forwarding rule is preliminarily loaded to the switches associated with the created forwarding rule to preliminarily configure switches for performing forwarding. Information about the first priority level is preliminarily generated and stored in the first table 12. The first table 12 may be referred to as a pro-active path table (PAP_table).

The second priority level is given to services that the end systems access less frequently, and a forwarding rule is preliminarily created for the services of the second priority level and information regarding this forwarding rule is stored in the second table 13. Unlike the services of the first priority level, the SFRM 11 preliminarily sets and manages a forwarding rule for the services of the second priority level, and then quickly loads the preliminarily set forwarding rule to the switches when traffic occurs to minimize service response time delay. The second table 13 may be referred to as a pro-ready path table (PRP_table).

For services of the third priority level, which are services other than the frequently requested services because the end systems access these services at a lower frequency than a given frequency, when traffic occurs, the corresponding packets are sent to the network controller 100 and managed to allow the network controller 100 to perform path selection and routing, and information regarding this is stored in the third table 14. The third table 14 may be referred to as a re-active path table (RAP_table), and is able to store and manage information about services other than frequently requested ones.

Meanwhile, the device manager 15 manages devices connected to the network, and the topology manager 16 collects and manages network topology information. The path manager 17 manages a traffic path, and sets a forwarding rule for switches associated with the path under the control of the SFRM 11.

The rule manager 18 manages basic rules for setting a traffic forwarding rule, and the statistical processor 19 performs the functions like collecting, statistically processing, and managing network traffic information.

An end system 500 including an end host 300 or server (application server or virtual application server) collects usage situation information regarding applications that are accessing a network between a host and a server or between servers. The usage situation information may be referred to as sApp (statistics_application). Specifically, the cumulated number of accesses to a network access service is collected and analyzed to determine services requested per unit of time (e.g., per week) and determine priority levels for these services, and this information is stored and managed as a frequently requested service list (also referred to as FRS_list). The frequently requested service list is loaded to the SFRM 11 of the packet forwarding rule control apparatus 10 when the corresponding end system (end host or server) joins the network. For example, when the end system joins an SDN (software defined network), the frequently requested service list is loaded to the SFRM 11 through SFRM-API. Based on the frequently requested service list, the SFRM 11 configures forwarding rule information about the corresponding end system and updates information about the first table 12 and the second table 13, and preliminarily installs the corresponding forwarding rules on the switches according to the priority levels of the services.

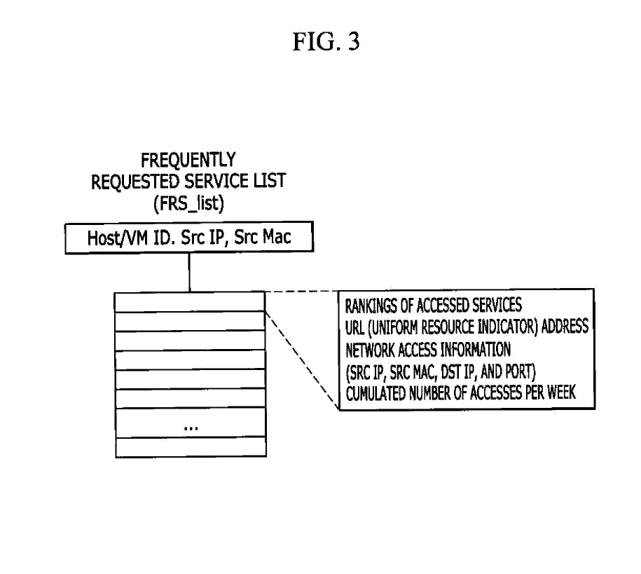

FIG. 3 is an illustration showing a frequently requested service list according to an exemplary embodiment of the present invention. As shown in FIG. 3, the frequently requested service list (FRS_list) collected and managed by the end system may include, as the rankings of accessed services, a URL (uniform resource locator) address, network access information (e.g., source IP address (Src IP), a source MAC address (Src MAC), a destination IP address (Dst IP), and port information, and the cumulated number of accesses per unit of time.

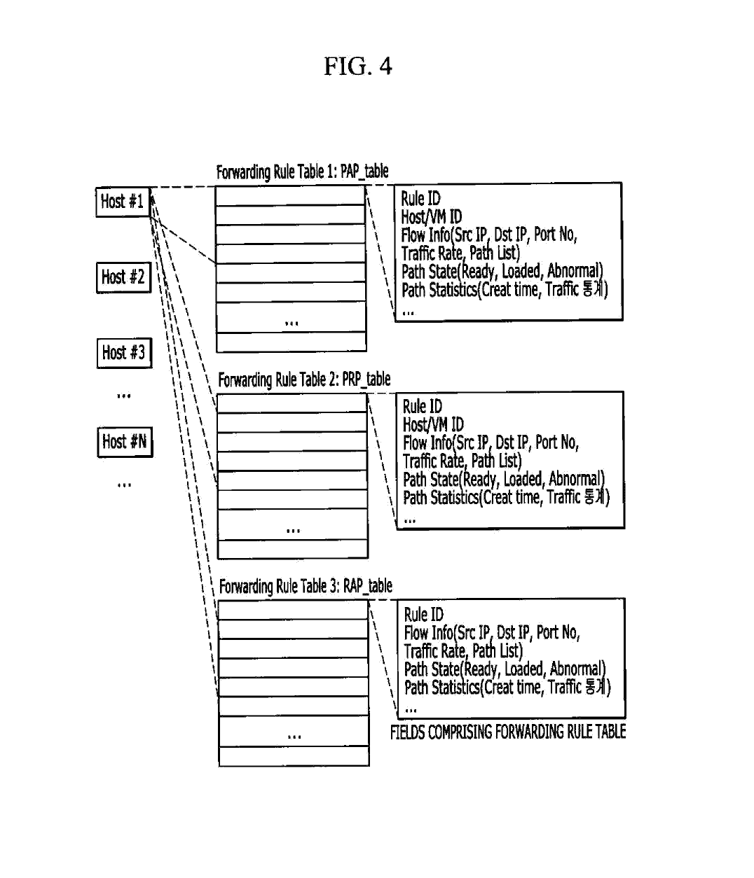

Forwarding rules are determined and set according to the priority levels of services, based on the frequently requested service list (FRS_list), and information regarding the forwarding rules managed by the first to third tables 12, 13, and 14 is as shown in FIG. 4.

FIG. 4 is a view showing the structures of tables according to an exemplary embodiment of the present invention. Particularly, FIG. 4 is a view showing the structures of the first to third tables storing information about forwarding rules for services of different priority levels.

The information about forwarding rules stored in the first table 11 (also referred to as PAP_table), the second table 13 (also referred to as PRP_table), and the third table 14 (also referred to as RAP_table) includes Rule ID, which is identification information about a set forwarding rule, Host/VM ID, which is identification information of an end system that has accessed a service, flow information (e.g., Src IP, Dst IP, Port No, traffic rate), Path List, Path State (Ready, Loaded, or Abnormal), and Path Statistics (e.g., Create time, Traffic Statistics Information, etc.).

Next, a method for setting a packet forwarding rule according to an exemplary embodiment of the present invention will be described based on this structure.

The method for setting a packet forwarding rule according to the exemplary embodiment of the present invention includes a procedure of setting a proactive forwarding rule (also referred to as a first forwarding rule) for a frequently requested service (service of the first priority level) having a high access frequency, a procedure of setting a pro-ready forwarding rule (also referred to as a second forwarding rule) for a service (service of the second priority level) having an intermediate access frequency, and a procedure of setting a reactive forwarding rule (also referred to as a third forwarding rule) for a service (service of the third priority level) having a low access frequency.

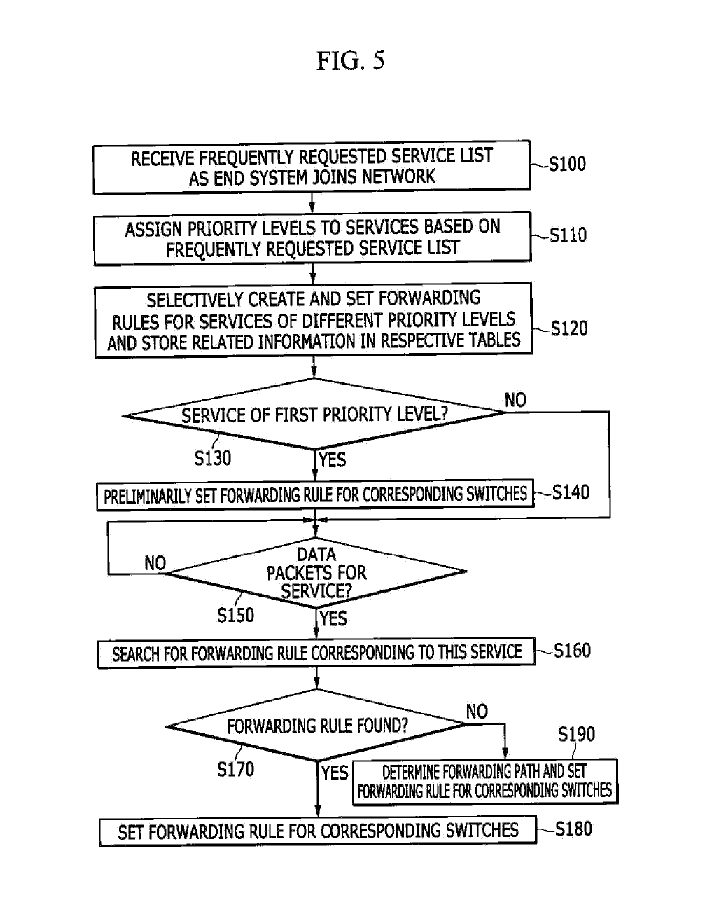

FIG. 5 is an overall flowchart of a method for setting a packet forwarding rule according to an exemplary embodiment of the present, invention.

When an end system such as an end host or server joins a network (e.g., SDN) (check-in process), a frequently requested service list (FRS_list) collected and managed by the end system is loaded to the SFRM 11 of the forwarding rule control apparatus (S100). The SFRM 11 assigns priority levels to services used by the end system based on the frequently requested service list (FRS_list) S110. For example, if the access frequency of a predetermined service is higher than a first set frequency, the first priority level is assigned to the service, if the access frequency of the service is lower than the first set frequency and higher than a second set frequency, the second priority level is assigned to the service, and if the access frequency of the service is lower than the second set frequency (second set frequency<first set frequency), the third priority level is assigned to the service.

The SFRM 11 selectively creates and sets forwarding rules for services of different priority levels, and stores and manages information about the created forwarding rules in the first through third tables, respectively (S120). The first forwarding rule setting procedure is performed on the service of the first priority level to create a forwarding rule, and the created forwarding rule is preliminarily set for the switches that will perform forwarding (S130 and 5140).

On this understanding, when data packets are generated upon a service request (S150), if the data packets correspond to the service of the first priority level, they are processed without network controller intervention according to the forwarding rule preliminarily set for corresponding switches. That is, the data packets corresponding to the service of the first priority level are not loaded to the SFRM 11, but instead are quickly processed by the preliminarily configured switches and loaded to the destination node.

On the other hand, data packets not corresponding to the service of the first priority level are loaded to the SFRM 11, and accordingly the SFRM 11 searches the second table in order to check whether any forwarding rule is set for the service corresponding to these data packets (S160).

When any forwarding rule set for this service is found from the second table, the second forwarding rule setting procedure is performed. That is, the SFRM 11 sets the forwarding rule for corresponding switches, and accordingly, the data packet is forwarded to the destination node along the path of the set forwarding rule (S170 and S180).

On the other hand, if no forwarding rule is found in the searching step S160, the third forwarding rule setting procedure is performed. That is, the SFRM 11 determines a path for forwarding this data packet and sets a forwarding rule for corresponding switches. Afterwards, the data packet is forwarded to the destination node along a determined path (S190).

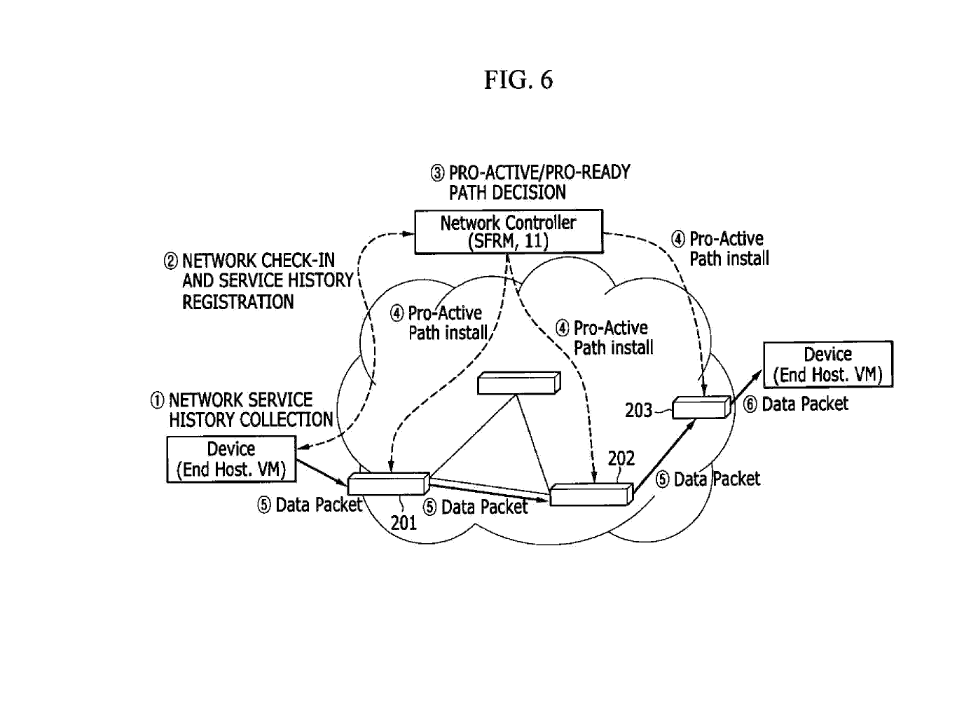

FIG. 6 to FIG. 8 illustrate first through third forwarding rule setting procedures in a packet forwarding rule setting method according to an exemplary embodiment of the present invention.

The proactive forwarding rule, i.e., first forwarding rule setting procedure, for a frequently requested service of the first priority level having a high access frequency will be discussed. As shown in FIG. 6, when the end system 500 loins an SON network (check-in process), a frequently requested service list (FRS_list) collected and managed by the end system 500 is loaded to the SFRM 11 of the network controller (\hat{1}\hat{2}). The SFRM 11 generates information regarding the first table (PAP_table) and the second table (PRP_table) based on the frequently requested service list (FRS_list) (\hat{3}). Next, forwarding rule information is preliminarily set for the corresponding open switches 201, 202, and 203 based on new path information created on the first table (PAP_table) (\hat{4}). Afterwards, when data packets are generated upon a request for a frequently requested service (\hat{5}), the data packets are quickly processed by the switches 201, 202, and 203 without network controller intervention according to the forwarding rule preliminarily set for the switches and loaded to the destination node (\hat{6}). By doing so, the load applied to the network controller is reduced, and as a result, the network size that the network controller can handle and the scalability for new flows can be ensured and service response delay time can be shortened.

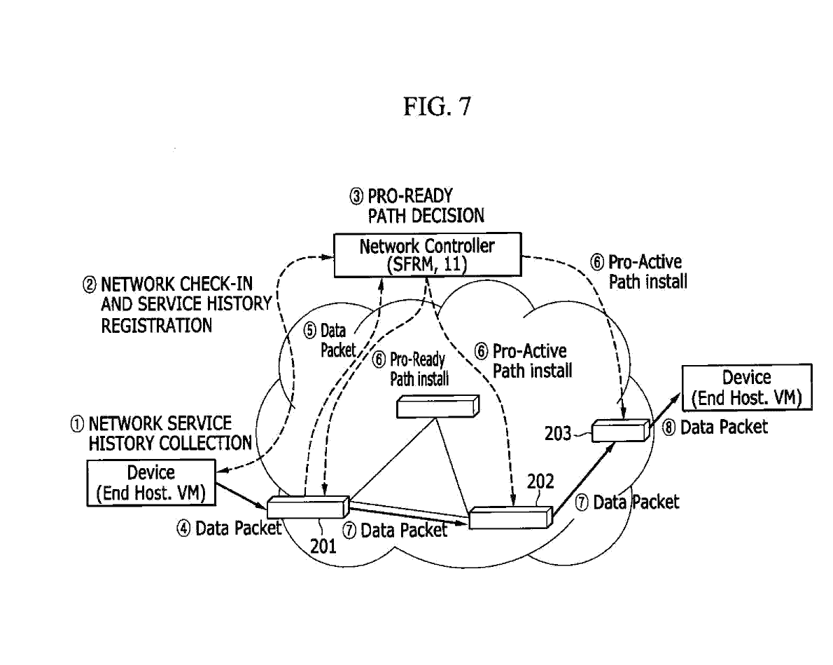

The pro-ready forwarding rule, i.e., second forwarding rule setting procedure, for a service of the second priority level having an intermediate access frequency will be discussed. As shown in FIG. 7, information regarding the first table (PAP_table) and the second table (PRP_table) is generated by the SFRM 11 and stored (\hat{1}\hat{2}\hat{3}). Afterwards, the forwarding rule for the second table (PRP_table) is not loaded to the switches, unlike the first forwarding rule setting procedure for preliminarily setting a preliminary path for the switches. Next, when data packets are generated upon an actual service request (\hat{4}), the data packets are sent to the SFRM 11 of the network controller (\hat{5}) because no forwarding rule for the data packets is looked up by the switches. The SFRM 11 searches the second table (PRP_table) first to find a matching forwarding rule, and if this forwarding rule is found in the second table (PRP_table), it then sets the forwarding rule for the switches 201, 202, and 203 (\hat{6}). Thereafter, the data packets are forwarded along a determined path (Pro-Ready path) (\hat{7}\hat{8}). At this time, the switches can selectively delete the forwarding rule for the Pro-Ready path.

Through the above-described process, an excessive increase in the number of forwarding rule entries to be maintained for the switches is prevented, the scalability of the network controller can be ensured, and service response delay time can be shortened.

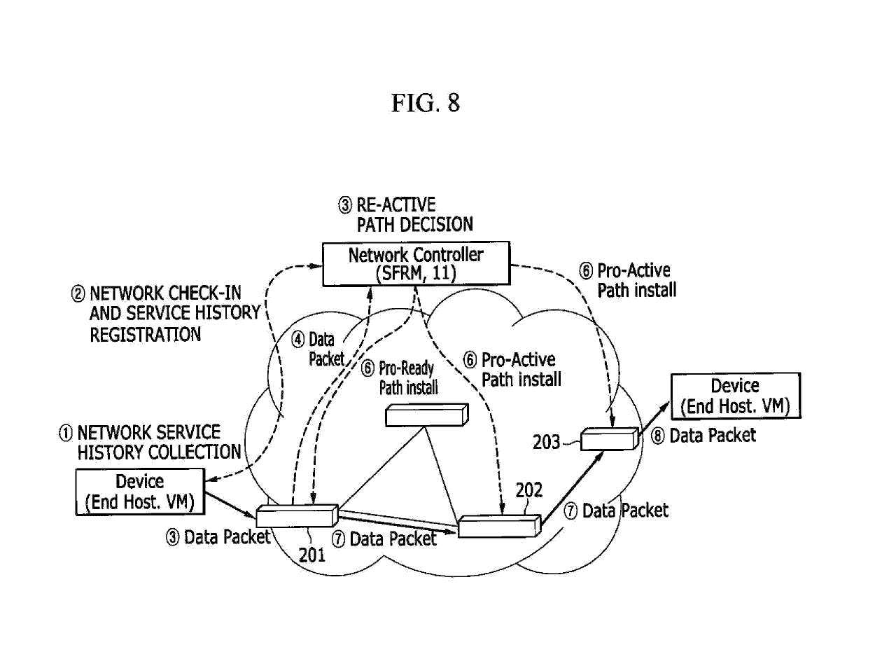

The reactive forwarding rule, i.e., third forwarding rule setting procedure, for a service of the third priority level having a low access frequency will be discussed. As shown in FIG. 8, the service of the third priority level does not undergo the process of preliminarily setting or creating a forwarding rule (\hat{1}\hat{2}). Accordingly, when data packets are generated upon an actual service request (\hat{3}), the data packets are sent to the SFRM 11 of the network controller (\hat{4}) because no forwarding rule for the data packets is looked up by the switches, and the SFRM 11 searches the second table (PRP_table) first to find a matching forwarding rule. Since no matching forwarding rule is found in the second table (PRP_table), a forwarding path is determined and loaded to the switches 201, 202, and 203 (\hat{5}\hat{6}). Thereafter, the data packets are forwarded along a decided path (Re-Active path) (\hat{7}\hat{8}). At this time, the switches can selectively delete the forwarding rule for the Re-Active path.

A process of performing the packet forwarding rule setting method according to an exemplary embodiment of the present invention will be described below in detail.

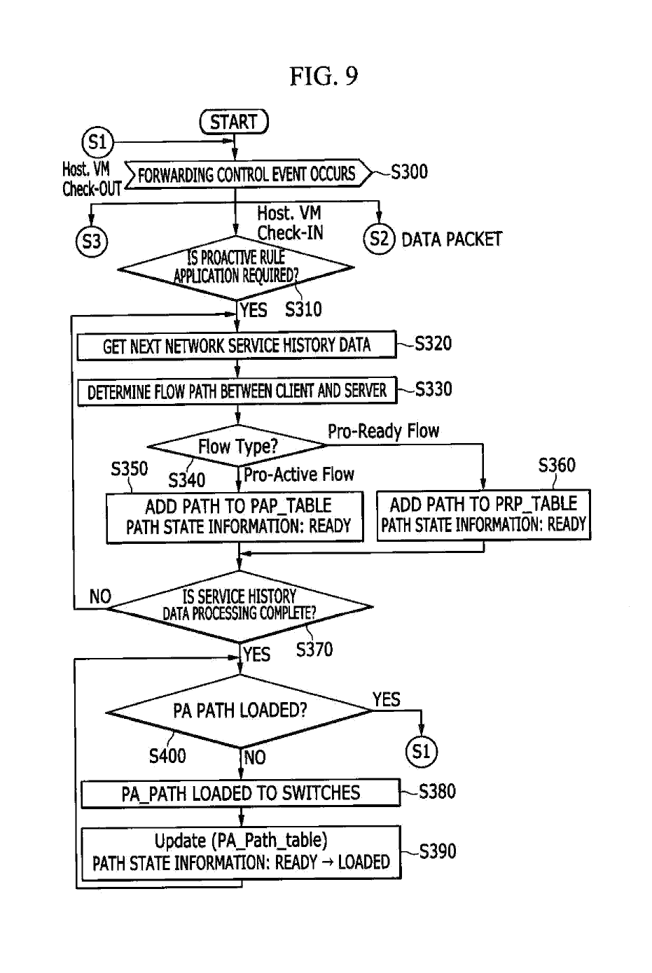

FIG. 9 to FIG. 12 are detailed flowcharts of a method for setting a packet forwarding rule according to an exemplary embodiment of the present invention.

As shown in the attached FIG. 9, when a forwarding control event occurs, such as when a new end system joins or leaves the network or new data packets enter the network controller, the SFRM 11 is triggered (S300).

When an event occurs in which a new end system (end host, virtual server, or application server) joins the network, the end system registers a frequently requested service list in the SFRM 11 by using a check-in API. If rule application is required because of the presence of the frequently requested service list (S310), the SFRM 11 assigns different priority levels to different services and receives network access information and requests the path manager 17 to create path information between the end system and the destination node (S320). The path manager 17 finds a path based on topology and resource information, device information, and resource allocation policies, and loads information about the found path to the SFRM 11 (S330). A variety of path finding mechanisms available in the, art may be used. The SFRM 11 registers, in the first table (PAP_table), path information for a service flow of the first priority level having the highest access frequency, and lists the path state as Ready (S340 and S350).

For a service of the second priority level, path information is registered in the second table (PRP_table), and the path state is listed as Ready (S360).

Once the configuration of path information for the service list loaded from the end system is completed by repeating the above process (S370), path information for the service of the first priority level is loaded to the corresponding switches to preliminarily set a path, and the path state is updated to Loaded (S380 and S390).

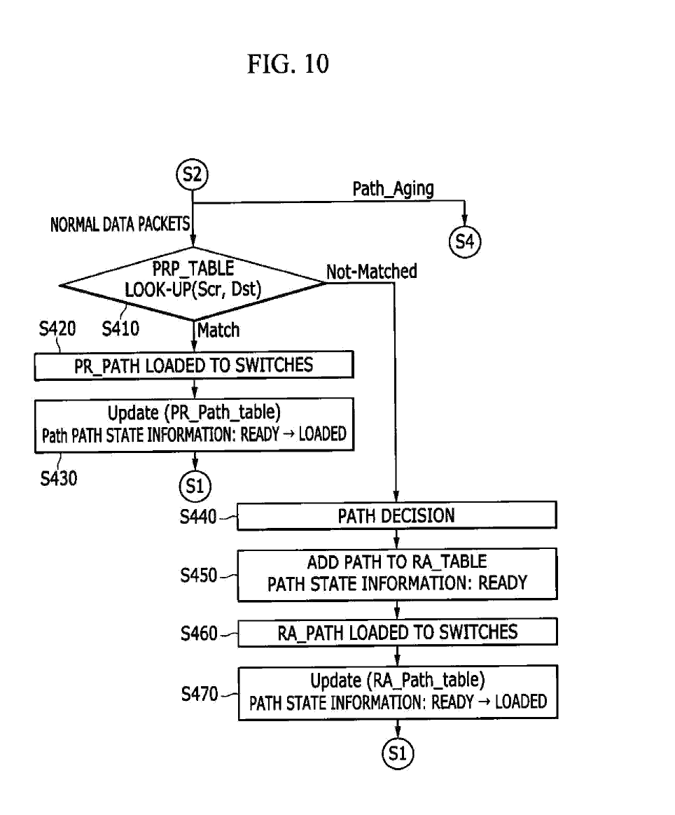

After completing the configuration for the corresponding switches based on the path information for the service of the first priority level (S400), when a forwarding control event occurs in which normal data packets are received, the same process as FIG. 10 is performed.

Since the received data packets correspond to the service of the second or third priority level, the SFRM 11 first looks up in the second table (PRP_table) (S410). If a matching forwarding rule is found in the second table (PRP_table), this forwarding rule is loaded to the switches to set a forwarding path (S420), and the path state is updated to Loaded (S430).

For packets corresponding to the service of the third priority level, no matching forwarding rule is found in the second table (PRP_table). Therefore, new path information is generated upon a request from the SFRM 11 (S440), the path information is registered in the third table (RAP_table), and the path state is listed as Ready (S450). Afterwards, the SFRM 11 loads a forwarding rule to the switches based on this path information to set a forwarding path (S460), and updates the path state of the path information stored in the third table (RAP_table) to Loaded (S470).

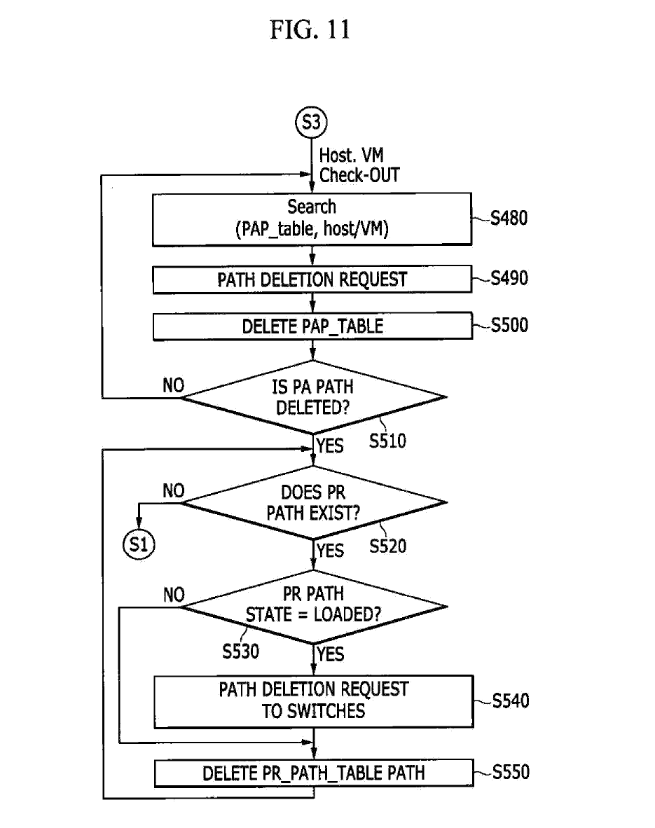

Upon receiving an event in which the end system (host, virtual server, or application server) leaves the SDN, which is a forwarding control event, the process shown in FIG. 11 is performed.

A check-out procedure is carried out between the end system and the SFRM 11 to delete the corresponding path information. First of all, the SFRM 11 finds the forwarding rules corresponding to the service of the first priority level registered in the first table (PAP_table) (S480), instructs the corresponding switches to delete these forwarding rules (S490), and also deletes the information registered in the first table (PAP_table) (S500).

After the paths corresponding to the service of the first priority level are deleted, the paths corresponding to the service of the second priority level are deleted (S510). If the state of path entries corresponding to the service of the second priority level stored in the second table (PRP_table) is Loaded (S520 and S530), the SFRM 11 instructs the corresponding switches to delete the forwarding rules (S540), and deletes the path entries of the second table (PRP_table) (S550). If the path state is Ready, only the entries registered in the second table (PRP_table) are deleted. By repeating this process, the processing of the path information of the second table (PRP_table) is completed.

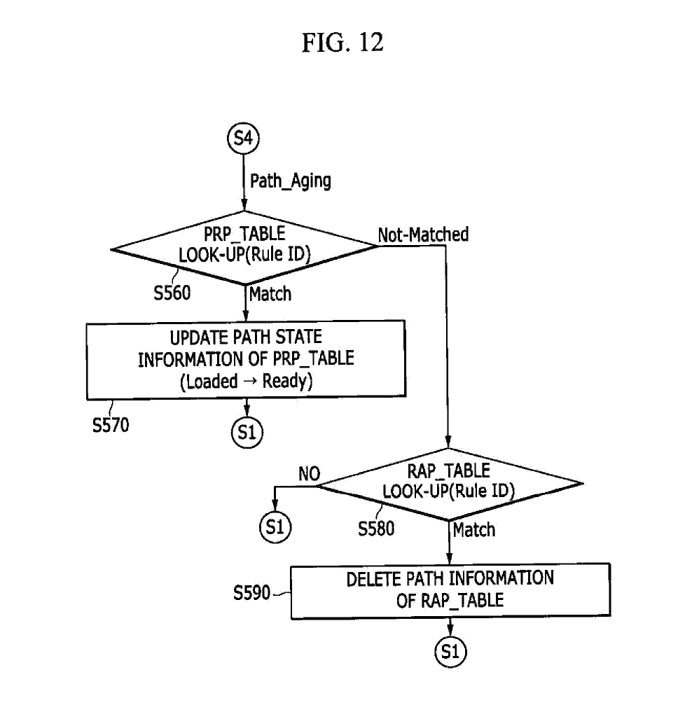

Upon receiving a Path_Aging event, which is a forwarding control event, from the switches, the process shown in FIG. 12 is performed.

To check whether a certain path corresponds to the service of the second priority level or not, the second table (PRP_table) is searched (S560). If there is a matching path in the second table (PRP table), the path state of this path stored in the second table (PRP_table) is updated from Loaded to Ready (S570).

On the other hand, if this path is not registered in the second table (PRP_table), the third table (RAP_table) is searched (S580), and the corresponding path information is deleted (S590).

According to an embodiment of the present invention, forwarding rules are classified into three priority levels and controlled and managed, based on the network service history of an end system in an open network based on centralized control, thereby reducing the load on the network controller to improve the scalability of the network controller and shortening service response delay time. That is, for most frequently requested services having a high access frequency, a forwarding rule is preliminarily created and set for switches, and for services having a low access frequency, a forwarding rule is preliminarily created but managed only by the network controller. Therefore, delay in service response time can be minimized, and an excessive increase of forwarding rule entries that switches need to maintain can be prevented.

The present invention suggests a method and apparatus for setting a forwarding rule which alleviate the problems such as limited scalability and increased service response delay time caused by the centralized control over forwarding rules in a control network, and do not increase the number of fixed paths that switches need to maintain.

The exemplary embodiments of the present invention may be implemented through the above-described apparatus and/or method, and may also be implemented with a program for realizing the functions corresponding to the elements of the exemplary embodiments of the present invention, and a recording medium storing the program. These implementations may be easily achieved from the description of the exemplary embodiments by a person of ordinary skill in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for setting a forwarding rule in a network comprising a plurality of switches, the method comprising:
receiving a frequently requested service list from an end system comprising an end host and a server;
assigning different priority levels to different services based on the frequently requested service list, and selectively setting a forwarding rule containing path information for forwarding data packets according to the priority levels;
preliminarily loading a first forwarding rule for a service of the first priority level to corresponding ones of the plurality of switches; and
storing and managing forwarding rules set for services other than the service of the first priority level, without preliminarily loading the same to the corresponding switches.

2. The method of claim 1, wherein the storing and managing comprises storing and managing a second forwarding rule set for a service of a second priority level, without loading the same to corresponding ones of the plurality of switches,
wherein no forwarding rule is set for services of a third priority level other than the service of the second priority level.

3. The method of claim 2, further comprising:
receiving of data packets; and
if the data packets correspond to the service of the second priority level, loading the second forwarding rule set for the service of the second priority level to the corresponding ones of the plurality of switches to forward the data packets.

4. The method of claim 2, further comprising:
if the data packets do not correspond to the service of the second priority level, determining that the data packets correspond to a service of the third priority level;
setting a third forwarding rule for the service of the third priority level; and
loading the third forwarding rule to corresponding ones of the plurality of switches to forward the data packets.

5. The method of claim 1, wherein when data packets are generated for the service of the first priority level, the generated data packets are immediately forwarded through the switches corresponding to the first forwarding rule.

6. The method of claim 2, wherein
the storing and managing comprises storing information regarding the first forwarding rule, set for the service of the first priority level in a first table, and storing information regarding the second forwarding rule set for the service of the second priority level in a second table, and
further comprises, after the preliminary setting, updating the state of a path corresponding to the first forwarding rule stored in the first table to Loaded.

7. The method of claim 6, further comprising:
setting the forwarding rules when the end system checks in to the network; and
deleting information regarding the forwarding rules from the tables when the end system checks out of the network.

8. The method of claim 1, wherein the frequently requested service list comprises the rankings of accessed services, a URL (uniform resource indicator) address, network access information including source IP address, source MAC address, destination IP address, and port information, and a cumulated number of accesses per unit of time.

9. A control apparatus for setting and controlling a forwarding rule in a network comprising a plurality of switches, the apparatus comprising:
a scalable forwarding rule manager that assigns different priority levels to different services based on a frequently requested service list provided from an end system comphsing an end host and a server, and selectively sets a forwarding rule containing path information for forwarding data packets according to the priority levels;
a path manager that preliminarily loads a first forwarding rule set for a service of a first priority level to corresponding ones of the plurality of switches;
a first table that stores information about the first forwarding rule set for the service of the first priority level; and
a second table that stores information about a second forwarding rule set for a service of a second priority level,
wherein the second forwarding rule for the service of the second priority level is stored and managed without being preliminarily loaded to corresponding switches.

10. The apparatus of claim 9, wherein the scalable forwarding rule manager sets no forwarding rule for services other than the services of the first and second priority levels.

11. The apparatus of claim 9, wherein,
upon receiving data packets, the scalable forwarding rule manager searches the second table to find a matching forwarding rule, and
if the data packets correspond to the service of the second priority level and the matching forwarding rule exists in the second table, loads the second forwarding rule set for the service of the second priority level to the corresponding ones of the plurality of switches.

12. The apparatus of claim 11, wherein,
if no forwarding rule matching the data packets exists in the second table, the scalable forwarding rule manager determines that the data packets correspond to a service of a third priority level and sets a third forwarding rule, and loads the third forwarding rule to corresponding ones of the plurality of switches.

13. The apparatus of claim 9, wherein, when data packets are generated for the service of the first priority level, the generated data packets are not provided to the scalable forwarding rule manager but are immediately forwarded through the switches corresponding to the first forwarding rule.

14. The apparatus of claim 9, wherein the first and second tables each comprise
a rule ID, which is identification information about a set forwarding rule, HostNM ID, which is identification information of an end system that has accessed a service, flow information, and path state,
wherein the flow information comprises at least either source IP address, source MAC address, destination IP address, port information, traffic rate, or path list, and the path state comprises at least either Ready, which indicates a state before path configuration, Loaded, which indicates the completion of path configuration, or Abnormal.

15. The apparatus of claim 9, wherein, if the end system checks out of the network, the information stored in the first and second tables is deleted.

16. The apparatus of claim 12, further comprising a third table that stores information corresponding to the service of the third priority level.
